(19) United States
(12) Patent Application Publication
(10) Pub. No.: US 2002/0039172 A1
(43) Pub. Date: Apr. 4, 2002

(54) Colored contact lens having a more natural appearance and method of making same

(76) Inventors: Gerardo J. Ocampo, Bridgeview, IL (US); Michael H. Quinn, Valparaiso, IN (US)

Correspondence Address: BRINKS HOFER GILSON & LIONE, INTELLECTUAL PROPERTY ATTORNEYS, NBC TOWER - SUITE 3600, 455 NORTH CITYFRONT PLAZA, CHICAGO, IL, 60611, US

(21) Appl. No.: 09/880,156

(22) Filed: Jun. 12, 2001

Related U.S. Application Data
(60) Provisional application No. 60/211,236, filed on Jun. 12, 2000.

(30) Foreign Application Priority Data
May 30, 2001 (AR) P010102581
Jun. 11, 2001 (EP) EP01/06598

(51) Int. Cl. G02C 7/04; G02C 7/02

(52) U.S. Cl. 351/162; 351/177

(57) ABSTRACT

A colored contact lens and a method of making same is provided. An image of an eye is recorded, optionally enhanced, separated into color pattern components, optionally enhanced, then each color pattern component printed on a contact lens, directly or indirectly. The end result is a natural looking contact that enhances the natural iris color or changes the apparent color of the natural iris.

This application claims under 35 U.S.C. § 119(e) the benefit of the filing date of U.S. Provisional Patent Application Ser. No. 60/211,236 filed Jun. 12, 2000.

### TECHNICAL FIELD

The present invention relates to making colored contact lens designs, especially lens designs that are created by separating out the different color designs from an image of a human iris and then printing each of the different color designs onto a contact lens to obtain a colored contact lens that replicates the complex appearance of the iris.

### BACKGROUND OF THE INVENTION

The initial attempts to modify or enhance the color of one's iris used contact lenses with a solidly colored area that covered the iris portion of the eye. One example of contact lenses of this type disclosed in U.S. Pat. No. 4,468,229 (Su) was a contact lens colored over at least a portion of its surface, comprising a copolymeric hydrogel material to which at least one reactive dystuff of a particular chemical formula is reacted. It is difficult to achieve multiple complex patterns with this technology.

Colored contact lenses were developed, such as those discussed in Wichterle, U.S. Pat. No. 3,679,504, in which an opaque lens having an iris of multiple colors was artistically drawn or photographically reproduced onto the iris portion of the lens. However, these lenses also failed to look natural, and as such never achieved commercial success. Other attempts to produce an opaque lens with a natural appearance are disclosed in U.S. Pat. Nos. 3,536,386 (Spivak); 3,712,718 (LeGrand); 4,460,523 (Neefe); 4,719,657 (Bawa); 4,744,647 (Meshel et al.); 4,634,449 (Jenkins); and in European Patent Publication No. 0 309 154 (Allergan) and U.K. Patent Application No.2 202 540 A (IGEL).

The first commercially successful opaque colored contact lens was manufactured based on the invention by Knapp as disclosed in U.S. Pat. No. 4,582,402. Knapp disclosed a contact lens having, in its preferred embodiment, colored, opaque dots, not a solidly colored iris portion. The Knapp lens provides a natural appearance with a lens that is simple and inexpensive to produce, using a simple one-color printed dot pattern. Although the intermittent pattern of dots does not fully cover the iris, it provides a sufficient density of dots that it creates a masking effect. The person wearing the lens has the appearance of a nearly continuous color when viewed by an ordinary observer. Knapp also discloses that the printing step may be repeated one or more times using different patterns in different colors, since upon close examination the iris is found to contain more than one color. The printed pattern need not be absolutely uniform, allowing for enhancement of the fine structure of the iris. The one-color Knapp lenses currently achieving commercial success have their dots arranged in an irregular pattern to enhance the structure of the iris.

Various efforts have been made to improve on the Knapp lens. U.S. Pat. No. 5,414,477, issued to Jahnke, discloses the application of intermittent ink patterns in two or three portions of distinct shades of colorant to provide a more natural appearance. The Jahnke disclosure describes a jagged border used to separate the distinctly colored portions, thereby enhancing the natural appearance of the colored lens. The Jahnke disclosure also describes three distinct colored portions and the use of multiple jagged borders to provide the necessary separation.

Other attempts to create a more natural appearing lens include U.S. Pat. No. 5,120,121 to Rawlings, which discloses a cluster of interconnecting lines radiating from the periphery of the pupil portion to the periphery of the iris portion. Further, European Patent No. 0 472 496 A2 shows a contact lens having a pattern of lines that attempts to replicate the lines found in the iris.

Despite these efforts, the contact lens industry continues to seek a low-cost, colored lens that can enhance or modify the color of the iris while providing its inherent depth and texture. This objective has been more closely achieved by providing colored contact lenses that allow some of the natural iris color and pattern to show through the colored lens.

### SUMMARY OF THE INVENTION

The present invention provides a colored contact lens. Preferably, the contact lens is produced by selecting an image of an eye of choice, breaking that image down into its component colors and patterns, processing the component colors and patterns, and reproducing those colors and patterns onto a contact lens, either directly or indirectly.

Initially, an image of a human eye may be recorded either by photographic means or some other reproduction means. Alternatively, an image of a human eye can be created by any graphical arts methods. Optionally, the recorded image can be enhanced at this time to achieve a particular cosmetic effect.

Next, the recorded image is processed to separate the image into its multiple component colors and their associated patterns. Optionally, these colors and patterns can be enhanced to achieve a particular cosmetic effect. The separation process can be done using a computer and commercially available software. These component colors and patterns are then used to manufacture multiple plates containing opaque or near-opaque portions, which can be used in the color lens manufacturing process. The colored lens is then manufactured by printing multiple layers of opaque or near-opaque portions in a particular order onto a contact lens using any known printing technique.

The recorded image, or some or all of the individual component colors, can be altered or modified in many different ways if desired, to produce a pattern suitable for changing the appearance of an eye. Such methods of alteration include removing some of the darker shades from the recorded image or the individual component colors; converting the component colors and their associated patterns into elements such as dots or islands of color; matching the component colors with available pigments and associated inks (such pigments and inks may be approved by the Food and Drug Administration, thereby increasing the chance of governmental approval); enhancing the recorded image or the component colors and patterns with additional colors and patterns, radial lines, contrast zones and the like; using certain mathematical algorithms such as two-dimensional Fourier transforms; and other manipulations of the patterns using software such as Adobe PhotoShop. Such modifications can be performed on the recorded image prior to processing the recorded image into separate component colors and patterns. The modifications may also be applied to the individual component colors after such processing.

The improvement in appearance over one-color lenses, two and three color lenses, and the other disclosures in which an attempt is made to replicate the human eye, is quite distinctive. Like certain previous color lenses, the lenses manufactured in accordance with this invention allow a fundamental change in the apparent color and color pattern of the wearer's iris. For example, it is not difficult to change the apparent iris color from dark brown to light blue or green, etc. Although the preferred embodiment of the invention is a four-color portion or layer lens, fewer or more than four layers are also contemplated. The number of layers is merely that desired by the operator who commands the software used to separate out the requested number of colors and patterns from the recorded image of the human eye. Generally, the more colors and patterns separated out and printed onto the colored contact lens, the closer the lens approximates the human eye and the desired cosmetic appearance effect on the eye.

One objective of a preferred embodiment of the invention is to provide a colored contact lens with a pupil section, an iris section surrounding the pupil section, and a colored pattern over the iris section. The colored pattern is preferably generated by recording a cosmetically appealing human eye or a photograph of such an eye, and then separating the recorded image into multiple component colors in their associated patterns. The multiple color separations are then used to create the different portions used in the printing process to manufacture the colored lens. A separate plate or cliché is created for each of the different portions consisting of the particular color separated out from the recorded image. These plates are then used to print each of the different colors or layers onto the contact lens or onto a film in a mold where a contact lens is formed, such that the film becomes part of the final contact lens. The final lens contains all of the layers and colors and closely replicates the image of the human eye that was originally recorded. The colored contact lens is capable of changing the apparent color and color pattern of the iris of a person wearing the lens, while imparting a very natural appearance.

The component colors and their associated patterns can be reproduced on contact lenses many ways. Rawlings' U.S. Pat. No. 5,116,112, incorporated herein by reference, discloses a printing method involving printing ink onto a layer or a film in a casting mold, forming a contact lens, and removing the contact lens so that the layer or film comprising the ink become part of the surface of the contact lens. Knapps' U.S. Pat. Nos. 4,704,007 and 4,582,402, incorporated herein by reference, disclose a method of pad printing contemplated for use with this invention. Other methods of reproducing an image on a contact lens such as laser printing and ink jet print are also contemplated.

Another objective of a preferred embodiment of the invention is to provide a colored contact lens with a pupil section, an iris section surrounding the pupil section, and a colored pattern over the iris section. The colored pattern can be generated by photographing a cosmetically appealing human eye, and then scanning the photographed human eye and storing the scanned image. Once stored, the scanned data can be separated into multiple component colors and patterns using separation software. The number of layers is merely that desired by the operator who commands the software used to separate out the requested number of colors and patterns from the recorded image of the human eye. A separate plate or cliché is created for each of the different color/pattern separations. These plates are then used during the printing of each of the different colors or layers onto the contact lens. The final lens contains all of the layers, colors and patterns and replicates the image of the human eye that was originally recorded. The colored contact lens is capable of changing the apparent color and color pattern of the iris of a person wearing the lens, while imparting a very natural appearance.

Another objective of a preferred embodiment of the invention is to provide a colored contact lens with a pupil section, an iris section surrounding the pupil section, and a colored pattern over the iris section. The colored pattern can be generated by recording a cosmetically appealing human eye or a photograph of such an eye, and then separating the recorded image into multiple component colors and their associated patterns. The multiple color separations are then used to create the different portions used in the printing process to manufacture the colored lens. A separate design is created for each of the different portions consisting of the particular color separated out from the recorded image. Various processes can be used to apply each of the different designs onto the contact lens. The final lens contains all of the layers or colors and replicates the image of the human eye that was originally recorded. The colored contact lens is capable of changing the apparent color of the iris of a person wearing the lens, while imparting a very natural appearance.

It can be understood that many different colored portions can be created depending on the human eye or photograph of the human eye that is used in the process. Further, depending on the separation software utilized, different layers or portions may be developed from the same human eye image. Also, the final product may differ, even if the same image is used, depending on the number of colors or layers that are separated out from the image.

The term “ordinary viewer” is intended to mean a person having normal 20-20 vision standing from about 2 about 5 feet from a person wearing the lenses of this invention.

### BRIEF DESCRIPTION OF THE DRAWINGS

The file of this patent contains at least one drawing or photograph executed in color. Copies of this patent with color drawings or photographs will be provided by the Patent and Trademark Office upon request and payment of the necessary fee.

FIG. 1 illustrates a design for a contact lens in accordance with the present invention;

FIG. 2 illustrates a colored image to be printed on a contact lens in accordance with the present invention;

FIG. 3 illustrates a first component color of the image of FIG. 2;

FIG. 4 illustrates a second component color of the image of FIG. 2;

FIG. 5 illustrates a third component color of the image of FIG. 2; and

FIG. 6 illustrates a fourth component color of the image of FIG. 2.

### DETAILED DESCRIPTION OF THE PREFERRED EMBODIMENTS

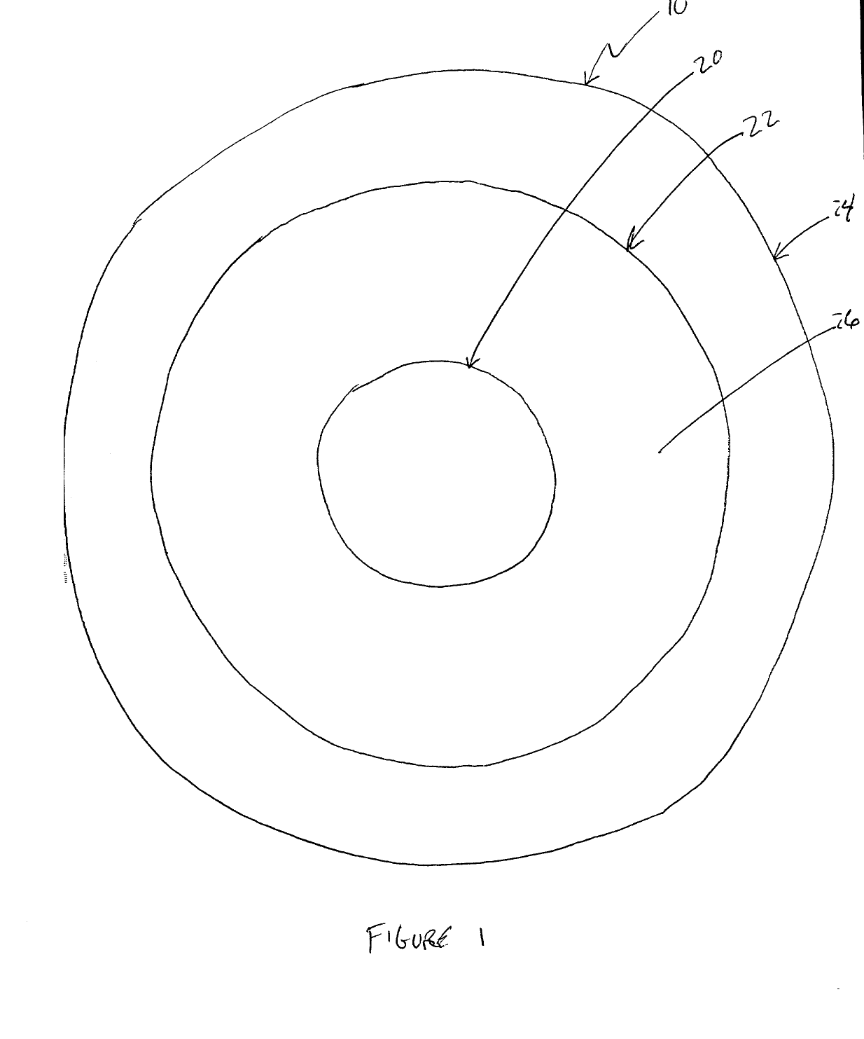

FIG. 1 shows a contact lens 10 in accordance with the present invention. It has a pupil section 20 in the center of lens, and an annular iris section 22 surrounding the pupil section. For hydrophilic or soft contact lenses, a peripheral section 24 surrounds iris section 22. A colored pattern 26 is located over the iris section 22. The pattern 26 is made up of multiple colored portions, each printed in its own pattern. The combination of these color patterns changes the apparent color and color pattern of the natural iris.

The pattern 26 located over the iris section 22 is created by combining multiple layers of different colored patterns together. To generate each of these multiple colored patterns, an image of a cosmetically pleasing eye (not shown) must first be recorded. The image of the eye can be photographed, painted, hand-drawn, printed or created by any well-known graphic design means. This includes chalk, pencil, ink, watercolor paintings, etc., as well as computer-created images.

The image is then recorded onto a medium such as a computer memory or the like. Recording the image can be accomplished by a number of different methods, such as scanning the image into the computer memory using a scanner, or capturing the image onto a computer memory or some other media using a digital camera, etc. The process of recording an image of the eye onto a computer memory may be one step, i.e., taking a picture of an eye with a digital camera.

Once the image of the cosmetically pleasing eye has been recorded or captured, the recorded image can optionally be enhanced using well-known means such as computer software like Adobe Photoshop.

Next, the recorded image may be separated into its component colors and their associated patterns. This separation of color patterns can be accomplished in many ways, including using computer software, such as Adobe Photoshop. The program separates the recorded image into its component colors or associated patterns. Each of the component color layers has a unique pattern that is dependent on the image of the eye that is being used, the computer program, and the operator's usage of the computer program. Each of the components can optionally be enhanced at this stage using any graphical arts methods.

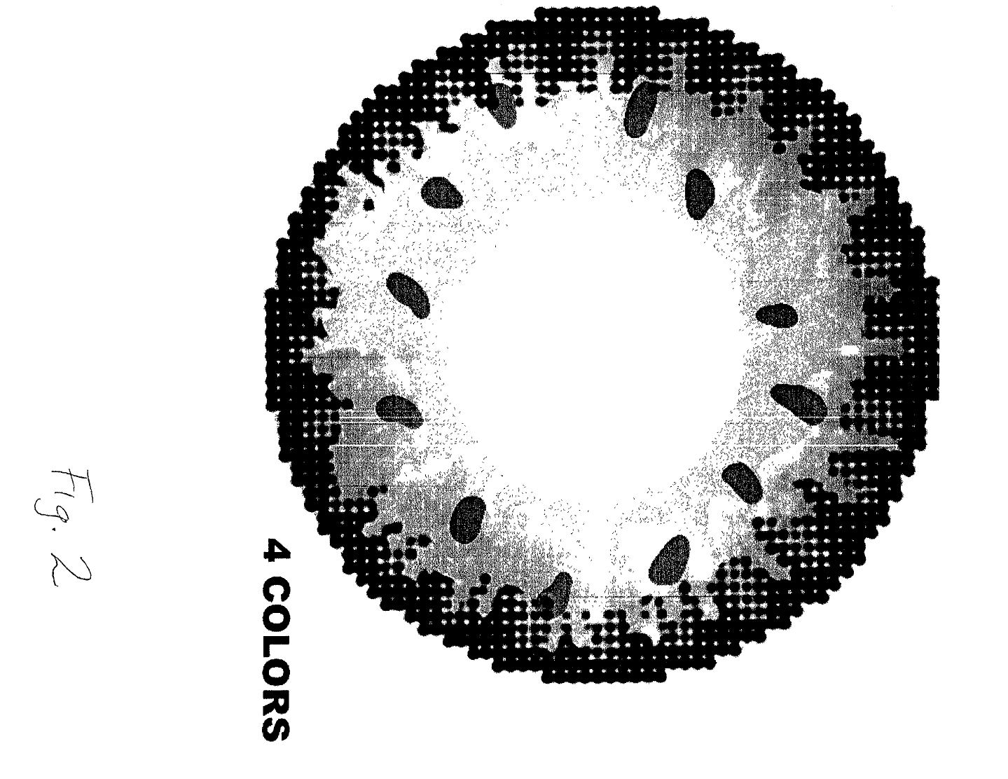

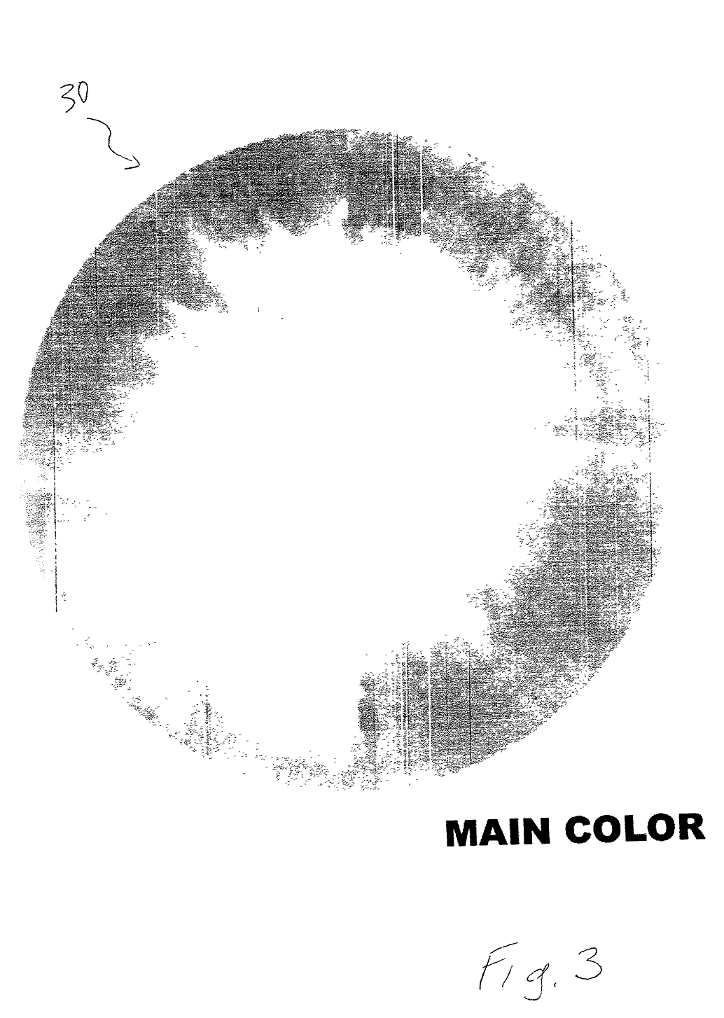

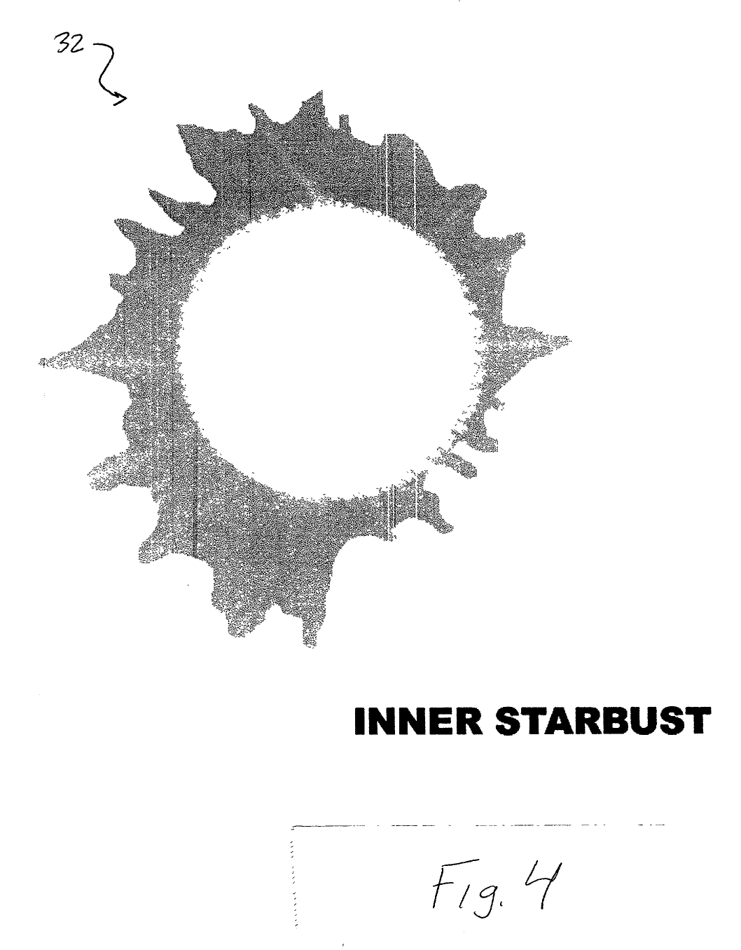

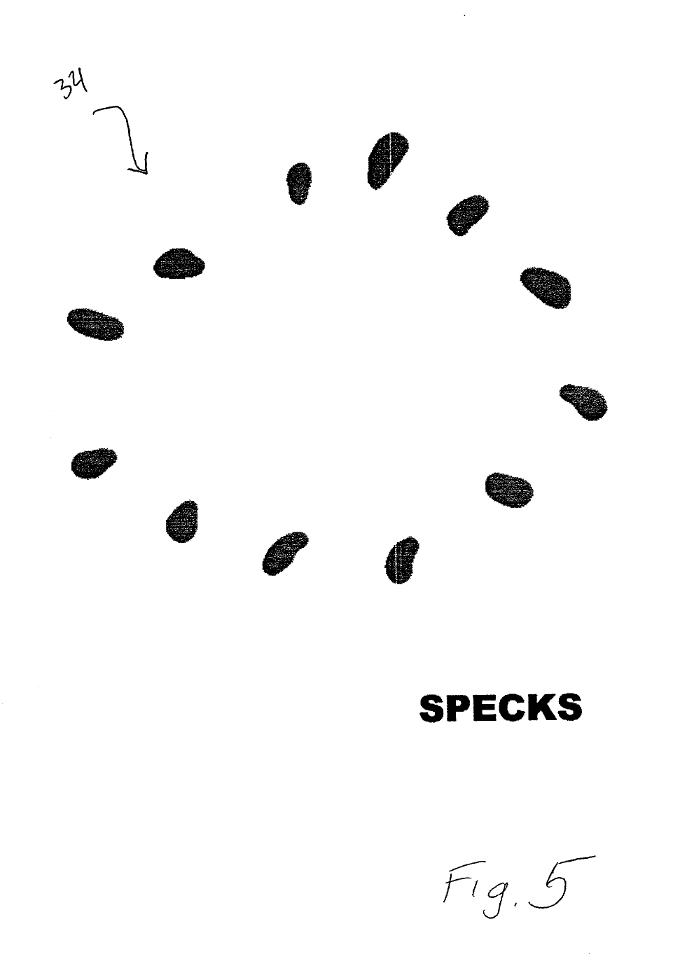

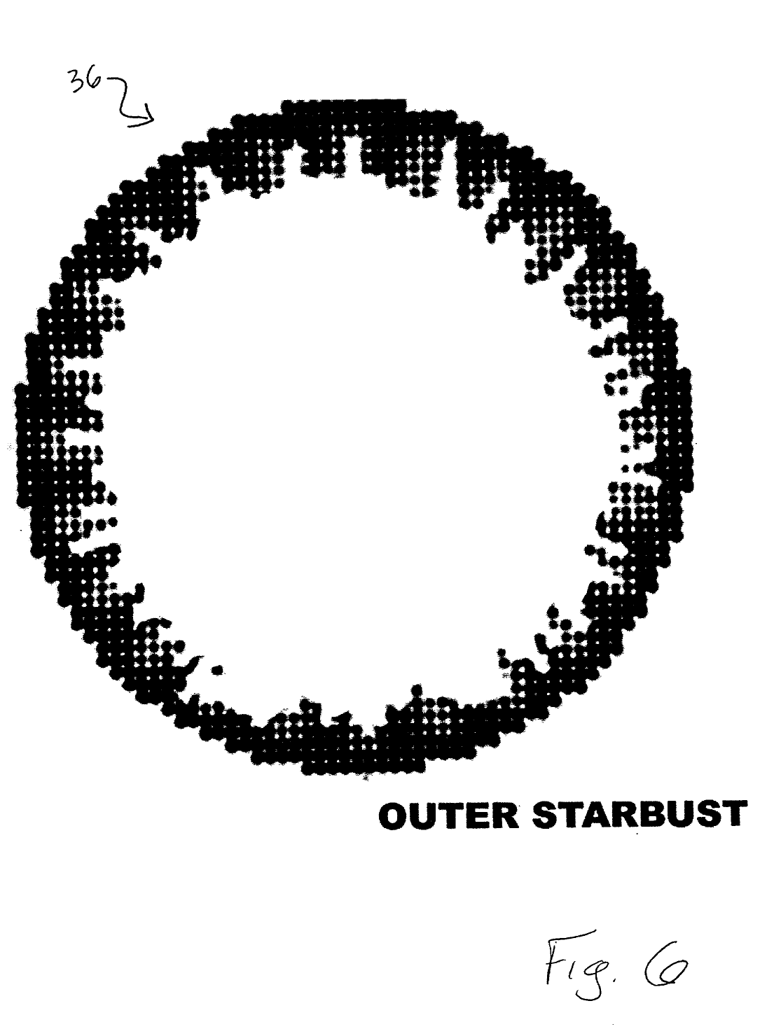

Referring to FIGS. 2-6, an image for a finished contact lens pattern is shown with each of its color pattern components. FIG. 2 is the finished image to be applied to the contact lens, and FIGS. 3-6 are the various color pattern components. The components can be printed on the lens (or on a film in a mold in which a lens is formed) in any order, although it is preferred to print FIG. 3, then FIG. 4, then FIG. 5, then FIG. 6.

FIG. 3 shows a colored layer 30, which is the main color pattern separated out from a cosmetically pleasing eye photograph. In this example, colored layer 30 is blue, and it covers the iris section 22 and the peripheral section 24, but not the pupil section 20. In preferred embodiments, blue or green colors dominate the middle iris area. One preferred blue ink paste has the formulation:

| Ingredient | Weight percent |
|---|---|
| Ethyl lactate | 30.55 |
| Binder soln. | 61.15 |
| PCN blue | 1.21 |
| TiO₂ | 7.09 |

One preferred green ink paste has the formulation:

| Ingredient | Weight percent |
|---|---|
| Ethyl lactate | 28.53 |
| Binder soln. | 63.85 |
| PCN blue | 0.03 |
| Cr₂O₃ | 7.59 |

FIG. 4 shows a colored layer 32 that covers, partially, iris section 22. Colored layer 32 is in a pattern known as an inner starburst. In the illustrated embodiment, the inner starburst is hazel. One preferred hazel ink paste has the formulation:

| Ingredient | Weight percent |
|---|---|
| Ethyl lactate | 30 |
| Binder soln. | 63.49 |
| PCN blue | 0.06 |
| I.O. Yellow | 4.3 |
| I.O. Red | 1.54 |
| TiO₂ | 0.61 |

FIG. 5 shows a colored layer 34 that covers, partially, iris section 22. Colored layer 34 is in a pattern known as specks. In the illustrated embodiment, the specks were drawn with a computer mouse after color separations had been made from a recorded image. In one preferred embodiment, the specks are an enhanced violet color. One preferred violet ink paste has the following formulation:

| Ingredient | Weight percent |
|---|---|
| Ethyl lactate | 22.5 |
| Binder soln. | 76 |
| Carbazole | 1.5 |

FIG. 6 shows a colored layer 36 that covers, partially, peripheral section 24. Colored layer 36 is in a pattern known as an outer starburst. In the illustrated embodiment, the outer starburst was drawn with a computer mouse after color separations had been made from a recorded image. In this example, colored layer 36 is black. One preferred black ink paste has the following formulation:

| Ingredient | Weight percent |
|---|---|
| Ethyl lactate | 23.98 |
| Binder soln. | 64.04 |
| I.O. Black | 11.98 |

All of the colors and their associated patterns ultimately combine to create a colored contact lens pattern simulating a cosmetically pleasing eye. In a preferred embodiment, four color layers are used: a black layer, a hazel layer, a gray layer, and a blue or green layer.

To produce a pattern that is suitable for changing the appearance of the eye, it may be preferable to modify or alter either the recorded image, or some or all of the individual component color patterns. There are many different ways to effect such an alteration. Using software, the darker shades of the recorded image or the individual component colors may be removed to modify the final appearance. Also, the component colors can be converted into elements such as dots or islands of color. This conversion may ease the printing process as described below. Further, the colors separated out during the process may be associated with pigments and inks that have been previously approved by the Food and Drug Administration. Such alteration may facilitate the acceptance of the colored contact lens.

The recorded image or the individual component colors can be enhanced by adding colors and patterns such as radial lines and contrast zones (i.e., lighter annular zones). Additional layers may enhance the appearance of the eye even further. The modification or alteration may also be done by manipulating the patterns using the software that was used to separate out the colors and patterns initially, or by using mathematical algorithms such as a two-dimensional Fourier transform to modify the pattern. A device for Fourier transformations is disclosed in U.S. Pat. No. 4,139,897, which is hereby incorporated by reference. Other enhancing techniques include but are not limited to using a computer program to paint, airbrush, halftone, sharp unmask, smudge, blur, defocus, tone, dodge, and sponge the recorded image.

Further, there are many other colors than those described above that can be separated out in accordance with the present invention. Other colors that can be separated from the cosmetically pleasing eye include brown, violet, cyan, magenta and yellow, among others. Further, the present invention is not limited to four layers making up the final pattern. In some cases, less than four colors may provide the amount of detail necessary. In some cases, depending on the software used to separate out the colored layers, more than four colors can be combined to create a final pattern. If the designer determines, for example, that there are traces of violet in a blue cosmetically pleasing eye photograph, the designer may add yet another layer of violet, a fifth layer. This additional layer adds another printing step, but it may provide an even more pleasing colored contact lens.

Depending on the desired cosmetic effect, the coloring on the iris portion of the lens can be adjusted to let very little of the natural iris show through or to let a substantial portion show through. Showing the natural iris can be accomplished by making each component layer into a pattern of colored elements that are separated by clear or translucent spaces or by perforating one or more of the patterns with clear or translucent spaces. How much iris a user wants to show through the lens depends on whether the use wants to achieve a color enhancing effect or a color changing effect. The more natural iris that shows through, the more of a color enhancing effect is achieved. The less natural iris that shows through, the more of a color changing effect is achieved.

In one preferred embodiment, from about 0.1% to about 20% of a person's natural iris color shows through. In another preferred embodiment, from about 21% to about 50% of the natural iris shows through. The color can be adjusted to allow about 51% to about 75% to show through or even from about 76% to about 99% to show through.

Another way to determine how much natural iris shows through depends on how much coverage the colored patterns have over the contact lens. Coverage means the ratio of the area covered by colorant to the total area in a given analytical field that is entirely within the applied pattern annulus. There are many ways to analyze coverage. One preferred way is to use a Bausch & Lomb Omnicon 5000 Image Analyzer according to the instructions in the manual.

Producing the colored pattern onto the iris section 22 is preferably accomplished by printing the lens four times, each time with a different color layer, using the known printing process of Knapp's U.S. Pat. No. 4,582,402, incorporated herein by reference, and the known printing process of Rawlings' U.S. Pat. No. 5,034,166, incorporated herein by reference and Rawlings U.S. Pat. No. 5,116,112, which was incorporated by reference above. Generally, a plate or cliche having depressions corresponding to the design generated in each colored layer, is smeared with ink of the desired shade. For example, FIG. 3 shows the blue layer, generated by separating out the blue color from the cosmetically pleasing eye photograph. A plate corresponding to the blue layer would be smeared with blue ink.

Excess ink is then removed from the plate by scraping the surface of the plate with a doctor blade, leaving the depressions in the plate filled with ink, in this case hazel ink. A silicon rubber pad is then pressed against the plate to pick up the ink from the depressions, and then the pad is pressed against a surface of the lens to transfer the pattern to the lens. The printed pattern is then cured to render it unremovable from the lens. Of course, either the anterior or posterior surfaces of the lens may be printed, but printing the anterior surface is presently preferred.

Both the anterior and posterior sides of the lens may be printed on by directly or indirectly. One may print an ink directly onto the male or female or both molds, charging the mold with a monomer, engaging the molds, and curing the lens-forming monomer and the ink together. A combination of printing on the m old followed by printing on the cured lens may also be performed, preferably by printing on the female mold followed by printing on the cured lens. This is a convenient way of achieving a double-sided print.

As described above, the preferred embodiment contemplates printing four layers in a particular order. However, neither the order of layers nor the number of layers is be so limited.

In one preferred embodiment, a blue colored contact lens would be created by printing the four colored layers pertaining to a blue cosmetically pleasing eye photograph, namely, black, hazel, gray and blue.

The preferred lenses and ink ingredients used to practice this invention are known and described in Loshaek's U.S. Pat. No. 4,668,240, incorporated herein by reference. The specific ingredients and target weights are described in detail below. Very briefly, a lens constructed of polymer having —COOH, —OH, or —NH₂ groups is printed with ink containing binding polymer having the same functional groups, opaque coloring substance, and a diisocyanate compound. First a mixture of binding polymer, pigments and solvent is prepared, and then mixed with more solvents and a diisocyanate to form an acceptable ink. The preferred binding polymer solutions have a viscosity of about 35,000 CPS for blue, gray, brown and black, and 50,000 CPS for green. The opaque ink is printed and cured on the lens surface. The lens chemistry need not be restricted to the above chemistry. For example, the system disclosed in Narducy, U.S. Pat. No. 4,857,072, does not require the above-mentioned functional groups to impart a colorant onto a lens.

Ink pastes and pigments that can be used in the present invention can be made in a number of different ways using the ingredients and percentages (by weight) as described below in the ink color charts. An ink paste is normally combined with an adhesion promoter to make an ink.

For example, a hazel ink paste can be made using 63.49 percent binder solution (by weight), 30.00 percent ethyl lactate, 0.61 percent titanium dioxide, 0.06 percent PCN blue, 4.30 percent iron oxide yellow, and 1.54 percent iron oxide red. Although these colors are used for the preferred embodiments, other colors or variations of the weight percentage of ingredients may be used. The charts below are merely a representative example of the possible inks and pigment levels, and are not a complete list. One having ordinary skill in the art could develop other inks and pigment levels that would provide an enhancing effect to the iris of a person wearing the contact lens.

| INK PASTE | BLUE | GRAY |
|---|---|---|
| COLOR CODE | Weight | Weight |
| Ingredient | Percent | Percent |
| Ethyl Lactate | 30.55 | 30.75 |
| Binder Soln | 61.15 | 59.84 |
| PCN Blue | 1.21 | |
| PCN Green | | 0.23 |
| TiO₂ | 7.09 | 7.34 |
| IO Black | | 1.83 |

| INK PASTE | BROWN | HAZEL |
|---|---|---|
| COLOR | Weight | Weight |
| Ingredient | Percent | Percent |
| Ethyl Lactate | 30.00 | 30.00 |
| Binder Soln | 55.10 | 63.49 |
| PCN Blue | | 0.06 |
| TiO₂ | | 0.61 |
| IO Black | 5.70 | |
| IO Red | 3.45 | 1.54 |
| IO Yellow | | 4.30 |
| IO Brown | 5.75 | |

| INK PASTE | GREEN | BLACK |
|---|---|---|
| COLOR | Weight | Weight |
| Ingredient | Percent | Percent |
| Ethyl Lactate | 28.53 | 23.98 |
| Binder Soln | 63.85 | 64.04 |
| PCN Blue | 0.03 | |
| IO Black | | 11.98 |
| Cr₂O₂ | 7.59 | |

Clear pastes can be added to any of the above formulations to lighten the colors. This may produce a more natural looking color when a color change is sought instead of a color enhancement. Any hydrophilic polymer paste may be used as the clear paste. In a preferred embodiment, the clear paste is a 9:1 copolymer of 2-hydroxyethyl methacrylate (HEMA) to 2-ethoxyethyl methacrylate (EOEMA) in cyclopentanone thinned in ethyl lactate.

The ink formulations may be made to penetrate the surface of the lens to create a perception of depth. Such inks and lenses are described in GB 0384632.

The colored pattern may be deposited onto iris section of the lens in any manner. Currently preferred methods include by offset pad printing, described below in some detail. Other alternative methods include the use of a laser (U.S. Pat. No. 4,744,647) or an ink jet printer.

A plate (not shown) is prepared having a flat surface and circular depressions corresponding to the desired colored layer to be printed. The plate may be made by a technique that is well known for making integrated analog or digital circuits. First, a pattern about 20 times as large as the desired pattern is prepared. Next, the pattern is reduced using well-known photographic techniques to a pattern of the exact desired size having the portion to be colored darker than the remaining area. A flat surface is covered by a photo resist material that becomes water insoluble when exposed to light. The photo resist an material is covered with the pattern and exposed to light. The portion of the photo resist pattern corresponding to the areas under the dark area of the pattern is removed by washing with water and the resulting plate is etched to the required depth. Then the remainder of the photo resist material is mechanically removed.

Colorant, comprising a pigment, binder or carrier for the pigment solvent and diisocyanate is deposited on the flat surface of the plate and scraped across the pattern with a doctor blade. This causes depressions to be filled with ink while removing excess ink from the flat surface.

A pad made of silicon rubber, impregnated with silicon oil for easy release, is pressed against the pattern, removing ink from the depressions. The ink on the pad is allowed to dry slightly to improve tackiness, then pressed against the front surface of the contact lens, depositing the ink in the desired pattern over the iris section. Of course the pad must have enough flexibility to deform to fit over the convex front surface of the lens. The printing step is repeated multiple times using the different color layer plates for each different color layer.

Next, the deposited layer is treated to render it resistant to removal from the lens under exposure to the ocular fluids that the lens will encounter when placed in the eye. The exact method of preventing removal depends on the material of construction of the lens and the pattern. Mere air-drying or heating the lens may suffice. For hydrophilic lenses, the techniques for coating the opaque pattern described in Wichterle, U.S. Pat. No. 3,679,504 (incorporated herein by reference), may be used.

Although the steps listed above place an order to the printing of the different colored layers, the order of printing, and the number of printings, may not be important to the present invention and other orders of printing, or number of printings, would be covered by the present invention.

An alternative embodiment for printing the different layers on the iris section 22 of the contact lens provides for ink-jet printing instead of pad printing of each layer. Ink-jet printing is accomplished without the need of pads or plates and can be administered at a higher resolution than pad printing, thereby providing for greater detail of each colored layer and a more natural final pattern on the iris section 22 of the contact lens.

Using ink-jet printing also reduces the number of devices that make contact either with the contact lens or with other devices. For example, a silicon pad must make contact with a plate or cliche initially and then with the contact lens itself. Contact between the parts tends to wear down the parts which will then require replacements. During the ink-jet process, the micro-nozzles do not physically make contact with the contact lens, nor with any other device. The chance of the micro-nozzle wearing out is thereby reduced.

Further, the ink-jet printer is electronically controlled such that changing from one color layer to a different color layer can be done easily, by computer control. Thus, once the cosmetically pleasing eye photograph or picture has been recorded, stored and separated into its multiple colored layers, each layer can be applied to the colored contact lens using an ink-jet process, thereby creating a colored contact lens capable of changing the apparent color and color pattern of the wearer's iris.

If an ink jet printer is used, one of skill in the art should adjust the ink to optimize it for ink jet printing. For example, a preferred ink contains at least one pigment. The pigment should be much smaller than an ink jet nozzle to prevent clogging during the printer process. Generally, this means that preferred pigments are 3 microns or smaller. Larger pigments can be ground into smaller particles to reduce potential clogging.

The preferred ink has a surface tension of at least 35 mN/m. Any surface tension parameter is acceptable so long as the ink jets adequately and spreads when it contacts the lens. Preferably, the ink breaks into well-defined streams of droplets based upon its surface tension. The surface tension of the ink can be adjusted by adding or removing diluents or surfactants.

A preferred ink has organic solvents. It can contain many solvents, including alcohols, glycols, ketones or esters. It is preferred, but not necessary, that the ink dry in less than 5 seconds. A preferred ink could optionally contain humectants (e.g., ethylene glyclol) and surfactants.

It is also preferred, for continuous ink jet operation, that the ink is charged by an electrode to drop away from the gutter and onto the printing surface. This can be achieved by many ways well known in the art, including by adding about 0.5% by weight of a salt.

The preferred ink flows easily in ink jet applications. Preferably, the ink has a viscosity of from about 1 centipoise to about 50 centipoise. More preferably, the viscosity is from about 2 to about 30 centipoise. Most preferably, the viscosity is between 5 and 15 centipoise.

The colorants can be printed in a single layer or in many layers, and in any pattern that achieves desirable cosmetic effects. Preferred patterns of colorants include those identified in U.S. Pat. Nos. 5,936,705; 5,414,477; and 5,272,010, which are hereby incorporated by reference.

The patterns that the single or multiple layers of colorants form on the contact lenses are preferably comprised of zones, and the zones may be comprised of shaped colored regions within the zones. The shaped region may further be comprised of dots. Examples of zones include: a single annular iris color zone with irregular inner and outer borders, multiple concentric annular zones, annular zones with outer and inner starbursts, and a single iris zone but irregular in structure along multiple radial lines. Examples of shaped colored areas within zones include circular areas, ovular regions, irregular elongated regions in worm-like shapes, radial segments, and combinations of these shapes In a preferred embodiment, the colored contact lens is coated with a binding solution. Binding can occur during or after printing. It is preferred that the binding solution be applied to only those regions of the contact lens that are not in the optical zone.

The process of coating the contact lens can be done by any method that is well known in the art. In one embodiment, the binding solution could be sprayed onto the lens. If this method is used, a mask should be placed over the optical zone of the lens before spraying occurs. In another embodiment, the binding solution could be coated onto the lens using printing pads.

The preferred solvent of the binding solution depends upon the method of coating used. If the spraying method of coating is used, the solvent should have a low viscosity. That is, it is preferred that the viscosity be less than 50 centipoise. If the printing pad method of coating is used, the solvent should have a higher viscosity. That is, it is preferred that the viscosity be greater than 100 centipoise. Viscosity can be adjusted by the addition or subtraction of polymer chains or by the addition or subtraction of a solvent. Organic mixtures are the preferred solvents.

Preferably the binding solution comprises at least one monomer. More preferably, the binding solution comprises at least one hydrophilic monomer and at least one hydrophobic monomer.

Any hydrophilic monomer that can act as a plasticizer can be used. The hydrophilic monomer can allow the printed material to deform with the lens without cracking. Among the preferred hydrophilic monomers are 2-hydroxyethyl methacrylate (HEMA), NVP, GMA, and DMA.

Any hydrophobic monomer can be used to improve the strength of the lens and to improve the solubility of the monomer in organic solvents. Among the preferred hydrophobic monomers are 2-ethoxyethyl methacrylate (EOEMA), MMA, and BMA.

Preferably, the binding solution contains an initiator. Preferably, a UV or heat-activating initiator is used.

Preferably, the binding solution makes a tightly cross-linked film that traps the colorants in the film. For this, it is preferable to add ethyleneglycol dimethacrylate. Swelling agents to allow penetration of the monomer into the contact lens and they improve adhesion. Preferred swelling agents include cyclopentanone or cyclohexanone.

Preferably, the binding solution contains an adhesion promotor. Preferably, the adhesion promotor is hexamethylene diisocyanate. Any adhesion promotor can be used, including those disclosed in U.S. Pat. No. 5,272,010, which is incorporated by reference herein.

Preferably, the binding solution contains a chain transfer agent. Preferably, the chain transfer agent is mercaptoethanol.

Any ink jet printer can be used with the present invention so long as it can be configured to print the inks as described above on contact lenses that have curved surfaces.

A preferred ink jet printer is either drop-on-demand (DOD) or continuous-jet. A preferred ink jet printer can print pixels of less than 150 microns in diameter, preferably less than 100 microns in diameter. To achieve this result, it is preferred that the drops of ink that are emitted from the nozzle have a volume of less than 100 picoliters, preferably less than 50 picoliters, and more preferably, less than 10 picoliters. Pixel size is measured using standard microscopy techniques, which are well known to those of skill in the art.

A preferred ink jet nozzle is sized to form drops of the preferred volume given the ink viscosity and thermal forces. The ink jet printer head should be adjustable to account for the curved surface of the contact lens. Preferably, the nozzles can face perpendicular to the lens surfaces, forming a hemisphere around the lens. Alternatively, the lens surface could be rotated. It might also be useful to index the printer head with the lens rotator for non-radially symmetrical lenses with a non-symmetrical pattern.

In a preferred embodiment, the ink jet heads are controlled through the use of a computer.

In a preferred embodiment, batch processing could be used to print many contact lenses in rapid succession. For example, a batch of eight lenses (one palate) could be sent to eight printer heads. Lifts push the lens cup to put the in the vicinity of the printer heads. The cups could be rotated in a controlled fashion. The print heads would jet on and off based upon instructions sent from the computer software. The lifts would then lower the lenses back on their palate. Then, the palate would be sent through a system to print or spray the binding solution over the lenses. Then, the lenses would be sent to a curing process to heat and dry the lenses.

Information about ink jet printers and ink jet technology is readily available through vendors such as Domino-Amjet in Gurnee Mills, Ill., as well as through “The Ink Jet Academy” which is held periodically in various locations throughout the world, including Barcelona, Spain and Orlando, Fla.

Through routine experimentation, one of ordinary skill in the art can optimize the process of printing colorants onto contact lenses using various quantifiable analytical techniques.

Opacity, or light reflectance can be optimized. The amount of light reflected by a solid ink pattern on a solid hydrogel can be measured to determine which dye/pigment combinations make the best colorant. The UV-Vis spectrometer can quantify this information.

The surface tension of the inks can be monitored using a Denoy ring and the dyamic contact angle (DCA) apparatus. The adhesion of the ink to the contact lens can be tested using the FDA-required abrasion test. See the FDA web site for more information at http://www.fda.gov. To determine if there are residual monomers in the finished contact lens, HPLC, LC/MS data is insightful.

It may be preferable to treat the lens or a mold with a primer to demold the lens consistently so that the lens is on the male side of the mold after demolding to increase the adhesion of the ink to the surface or to enhance the hydrophilic ingredients that are introduced into the mold. Such primers are described in U.S. Pat. Nos. 5,158,718 and 5,894,002, which are incorporated herein by reference.

It can be seen that the present invention provides colored contact lenses capable of changing the appearance of the wearer's iris. Various changes may be made in the function and arrangement of parts: equivalent means may be substituted for those illustrated and described; and certain features may be used independently from others without departing from the spirit and scope of the invention as defined in the following claims.

1. A method of designing a colored contact lens having a very natural appearance, comprising:
a) recording an image of a cosmetically appealing eye; and
b) separating the recorded image into a plurality of component colors and patterns that can be reproduced on a contact lens.

2. The method of claim 1, wherein the image is an actual eye or a facsimile of an actual eye.

3. The method of claim 2, wherein the facsimile of an actual eye is a photograph.

4. The method of claim 1, wherein the image is created using graphic design means.

5. The method of claim 4, wherein the graphic design means is selected from the group consisting of a software package, a pencil drawing, an ink drawing, a chalk drawing, a water-color painting, an oil painting, and combinations thereof.

6. The method of claim 1, wherein the image is a graphically-enhanced facsimile of an actual eye.

7. The method of claim 6, wherein the image is graphically enhanced using graphic design means.

8. The method of claim 7, wherein the graphic design means is selected from the group consisting of a software package, a pencil drawing, an ink drawing, a chalk drawing, a water-color painting, an oil painting, and combinations thereof.

9. The method of claim 8 wherein when the graphic design means is a software package, the graphical enhancements are achieved by a method selected from the group consisting of painting, airbrushing, halftoning, sharp unmasking, smudging, blurring, defocusing, toning, dodging, sponging, and combinations thereof.

10. The method of claim 1, wherein the step of recording the image comprises scanning the image.

11. The method of claim 10, wherein scanning comprises automatically storing the image in a computer memory.

12. The method of claim 11, wherein storing the image in a computer memory comprises using a computer program.

13. The method of claim 11, further comprising enhancing the recorded image.

14. The method of claim 13, wherein enhancing is achieved using a computer program to perform tasks selected from the group consisting of painting, airbrushing, halftoning, sharp unmasking, smudging, blurring, defocusing, toning, dodging, sponging, and combinations thereof.

15. The method of claim 11 wherein the recorded image comprises elements having a particular density, the method further comprising varying the density of the elements.

16. The method of claim 11, wherein the step of separating the recorded image comprises using a computer program to divide each component color or associated pattern from each other component color or associated pattern.

17. The method of claim 16, wherein the component color comprises a color selected from the group consisting of brown, blue, gray, green, cyan, magenta, yellow, black, violet and hazel.

18. The method of claim 1, wherein the plurality of component colors consists of four component colors.

19. The method of claim 18, wherein the four component colors are black, hazel, gray and a color selected from the group consisting of brown, blue and green.

20. The method of claim 18, wherein the four component colors are printed in the order comprising black, hazel, gray, and either blue, brown or green.

21. The method of claim 1 further comprising altering at least one of the plurality of component colors.

22. The method of claim 1 further comprising altering at least one pattern.

23. The method of claim 1 wherein component color or pattern is reproduced on the contact lens by printing the color or pattern directly onto a contact lens.

24. The method of claim 1 wherein component color or pattern is reproduced on the contact lens by printing the color or pattern onto a film in a mold used to make contact lens such that when the contact lens is formed in the mold, the film becomes part of the contact lens.

25. A method of manufacturing a colored contact lens having a very natural appearance, comprising:
a) recording an image of a cosmetically appealing eye;
b) separating the recorded image into a plurality of component colors; and
c) transferring each of the plurality of component colors onto a contact lens.

26. The method of claim 25 further comprising altering at least one of the plurality of component colors.

27. The method of claim 25, wherein transferring comprises:
a) providing a plurality of clichés for use in the pad printing process, wherein each cliché corresponds to each of the plurality of component colors;
b) applying one of a plurality of component color inks to each of the cliches, wherein each of the plurality of component color inks corresponding to each of the plurality of component colors;
c) coating a plurality of pads with each of the plurality of component color inks, wherein each of the plurality of pads corresponding to each of the clichés;
d) placing each of the plurality of pads in direct contact with a contact lens, such that the contact lens obtains each of the plurality of component color inks, thereby manufacturing a color contact lens having a very natural appearance.

28. The method of claim 25, wherein transferring comprises:
a) providing a plurality of clichés for use in the pad printing process, wherein each cliche corresponds to each of the plurality of component colors;
b) applying one of a plurality of component color inks to each of the clichés, wherein each of the plurality of component color inks corresponding to each of the plurality of component colors;
c) coating a plurality of pads with each of the plurality of component color inks, wherein each of the plurality of pads corresponding to each of the clichés;
d) placing each of the plurality of pads in direct contact with a film in a mold such that when a contact lens is formed in the mold, the film becomes part of the contact lens, thereby manufacturing a color contact lens having a very natural appearance.

29. The method of claim 25, wherein transferring comprises applying each of the plurality of component color inks in a corresponding color design, to the contact lens, using an ink-jet printer, thereby manufacturing a color contact lens having a very natural appearance.

30. The method of claim 25, wherein transferring comprises applying each of the plurality of component color inks in a corresponding color design, to the contact lens, using an ink-jet printer, thereby manufacturing a color contact lens having a very natural appearance.

31. The method of claim 25, wherein transferring comprises printing each of the plurality of component color inks onto a surface in a casting mold, forming the contact lens therein, and removing the contact lens from the mold such that the surface in the casting mold becomes attached to the contact lens before the lens is removed from the mold.

32. A colored contact lens comprising:
a pupil section;
an iris section surrounding the pupil section; and
a colored intermittent pattern made up of a plurality of component colors and designs located over the entire iris section, the pattern covering an effective amount of the iris section to change the apparent color and color pattern of the iris, the pattern comprising: a plurality of component colors, each of the plurality of component colors corresponding to a particular design, each of the plurality of component colors and particular designs corresponding to a component color and particular designs in an actual eye, wherein each of the component colors and particular designs is determined by recording an image of a cosmetically appealing eye, separating the image of the recorded image into the plurality of component colors and particular designs, and transferring the plurality of component colors and particular designs to a contact lens, thereby creating a contact lens having a very natural appearance.

33. The lens of claim 32 wherein from about 0.1% to about 20% of a person's natural iris color shows through the lens.

34. The lens of claim 32 wherein from about 21% to about 50% of a person's natural iris color shows through the lens.

35. The lens of claim 32 wherein from about 51% to about 75% of a person's natural iris color shows through the lens.

36. The lens of claim 32 wherein from about 76% to about 99% of a person's natural iris color shows through the lens.
